(19) United States
(12) Patent Application Publication
(10) Pub. No.: US 2007/0241523 A1
(43) Pub. Date: Oct. 18, 2007

(54) Method and apparatus for repairing vehicles

(76) Inventor: Gregory Lynn Lewman, Coffeyville, KS (US)

Correspondence Address: Gregory Lynn Lewman, 2064 Douglas Rd., Coffeyville, KS, 67337, US

(21) Appl. No.: 11/405,123

(22) Filed: Apr. 17, 2006

(51) Int. Cl. A01D 75/00

(52) U.S. Cl. 280/32.5

(57) ABSTRACT

A method and apparatus for repairing a hard to reach vehicle comprising a movable base with an elevated platform with a central support means connected to a platform that is powered by a screw jack that is used to adjust the angle and height of the rotating platform wherein the user can easily reach formerly hard to access locations to facilitate repairs thus also relieving stress, fatigue, and back pain for the user.

### BACKGROUND OF THE INVENTION

1. Field of the Invention

The invention pertains to the field of creepers, scooter boards and/or other tools or supports as may be used by mechanic in the field of automotive repair. When a mechanic works under a car he would typically use a creeper for positioning himself in the proper position to do the repair. However, many mechanics when working over an engine compartment have to lean over the vehicle to position them selves for facilitating the repair thus causing stress, fatigue, and back pain.

2. Description of Related Art

A mechanics can be faced with various obstacles when working on a vehicle's engine compartment. Off road trucks with lift kits and large tires can even be more troubling because they are much higher off the ground. A common obstacle for a mechanic is leaning over the engine and reaching all of the necessary parts of the engine to facilitate repairs.

There have been numerous patents that have attempted to solve the problems associated with placing a mechanic in the proper position to effectively do his work. However, many inventions are designed for under vehicle access and do not assist the mechanic in over the engine repair. Examples of these inventions include U.S. Pat. No. 6,199,877, “Transformable mechanics creeper”, Shockley (2001) disclosing a transformable mechanics creeper.

U.S. Pat. No. 6,095,532, “Folding creeper”, Martin (2000) furthermore details a creeper that has telescopic braces or extensions or U.S. Pat. No. 6,059,298 “Foldable creeper”, Tucker (2000), showing a foldable creeper having caster wheels and two rectangular platform sections with padded cushions. These creepers are all designed for under vehicle access and do not assist a mechanic working on top of an engine compartment.

There have also been numerous patents designed to raise a mechanic above the engine compartment, but these patents are limited in there attempt to solve the problem of proper placement of the mechanic. Examples of such patents include U.S. Pat. No. 6,641,146 “Creeper with an elevated platform”, Reese (2003) detailing a modified engine hoist structure with an adjustable platform or U.S. Pat. No. 5,899,297 “Adjustable Workman's Bed System” Clark (1999) detailing an adjustable bed that is extended over an engine compartment.

Some other examples include U.S. Pat. No. 4,964,487 “Device for Supporting a Mechanic” Webb (1990) describing a lifting platform with a jackscrew lifting element or U.S. Pat. No. 6,105,719 entitled “User Configurable Mechanics Tool”, Lensing (2000) describing an elevated platform with an extendable ladder.

Furthermore U.S. Pat. No. 5,460,392 “Height Adjustable Universal Creeper Apparatus” Hansen (1995) is typical of many of these inventions in that they typically provide for an elevated platform with a climbing means to reach the platform. U.S. Pat. No. 4,618,029 “Adjustable Apparatus and Method for Assisting in Motor Vehicle Engine Repair”, Lowey (1986) Also describes a similar elevated platform with a ladder for reaching the platform.

One main obstacle every mechanics faces when working on a larger vehicle is obtaining the correct positioning over the engine. There have been many patents issued in the past to try and solve this problem, but their height adjustment is generally difficult to accomplish and many times requires manually reconfiguring the apparatus for height adjustment.

Another problem with prior art is that all past art typically allows for a flat vertical support and does not allow for angled adjustments wherein a mechanic may require a particular degree or angle in order to reach a specific repair site. Many elevated creepers require that you climb up on a platform and lay down thus hindering a mechanic less mobile to do the repairs and to access tools.

Prior art shows that most elevated mechanic's creepers and supports require difficult adjustments adding additional time to the repair and are typically difficult to use. Therefore, there is a need in the industry for an easy to use adjustable mechanic's elevated support with easy adjustments for height, angle and extension.

### SUMMARY OF THE INVENTION

In view of the foregoing disadvantages inherent in the known types of mechanic's creepers and supports of various designs and configurations demonstrated within the prior art, the present invention provides an improved and novel means for an easy to use, elevated apparatus for repairing larger or high vehicles.

The general purpose of the present invention, which will be described subsequently in greater detail, is to provide a new, improved, and easily adjustable method and apparatus for a mechanic to facilitate repairs on difficult to reach vehicles such as, but not limited to large trucks or the like. Said invention shall provide many advantages not currently seen in the field and shall provide for new and novel advantages over the prior art

The present invention is a new and improved adjustable elevated and angled mechanic's creeper and can otherwise be known as a workman's support bed system or work platform and provides a support surface for a mechanic to be selectively positioned over engine compartment and to facilitate his convenient positioning easily with the use of a single powered control means.

Said invention comprising a platform with an extended bed formed of a rigid material in a generally planar configuration with said platform having a central pivoted connection means in a rectilinear configuration extending downwardly from a central support plate and a second connection means wherein a electric powered cylindrical screw jack or like power means may be attached to said connection means and support means affixed on the mast wherein extension of jack allows for angle and height adjustment by a single power control means. The mast structure being height adjustable by the electric powered cylindrical screw jack and in direct communication with a base structure formed with a rigid material such as tubular steel or like with said base having a plurality of rolling castors wherein said base shall support a central mast support means extending upwardly and adjustable from a central extent of the base horizontally positioned thereon for receiving supporting adjustable support base wherein bed structure may be powered by a electric powered cylindrical screw jack or similar lift power means.

The invention is preferably used to repair but is not limited to cars, pickup trucks, medium and heavy duty trucks, tractor trailer trucks, boats, farm equipment, farm tractors, buses, planes, trains, and construction or like equipment.

From the foregoing, it will be apparent that the present invention provides for a novel mechanics tool and whereas the present invention has been described in particular relation to the drawing attached hereto, it should be understood that other and further modifications apart from those shown or suggested herein may be made within the scope of the invention.

### BRIEF DESCRIPTION OF THE DRAWINGS

FIG. 1 shows an exploded perspective view of the mechanical components of the invention in a preferred embodiment of the invention.

FIG. 2 shows a partial elevation view of the invention in a preferred embodiment of the invention showing mechanical and electrical components.

FIG. 3 shows an elevation view of the invention and height adjustment tool before height adjustment.

FIG. 4 shows an elevation view of the invention and height adjustment tool after height adjustment.

### DETAILED DESCRIPTION OF THE INVENTION

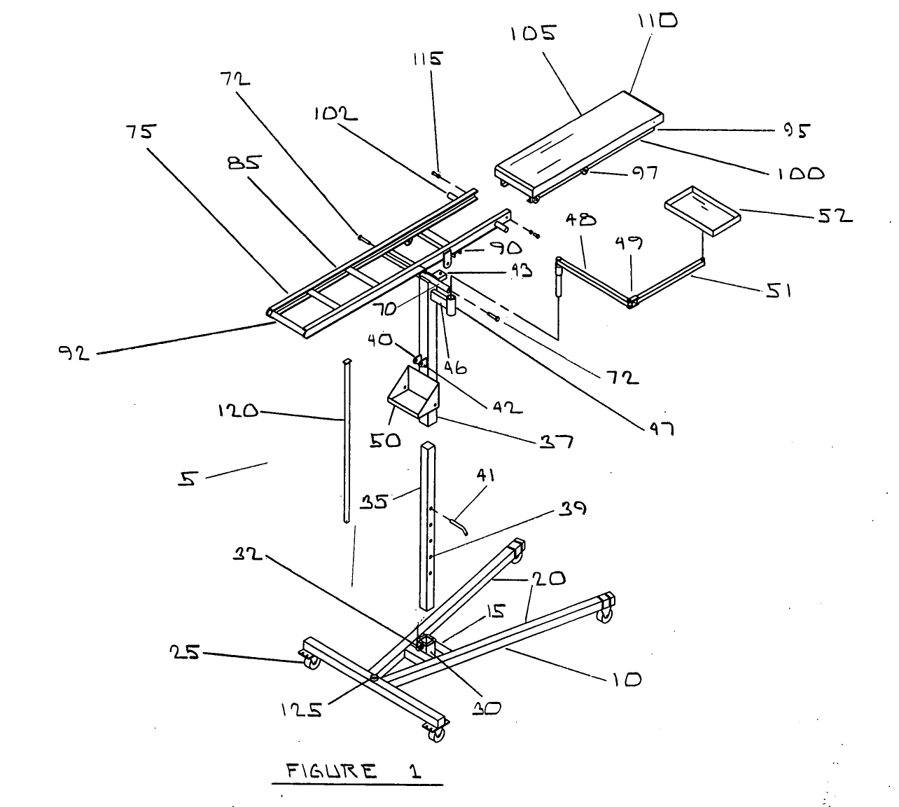

FIG. 1 references an exploded perspective view showing the invention in detail wherein the invention 5 comprises a movable base structure 10 built preferably with a rigid construction of steel, aluminum or like tubular material welded or otherwise formed to construct a movable base preferably in an a-frame configuration with a central brace means 15.

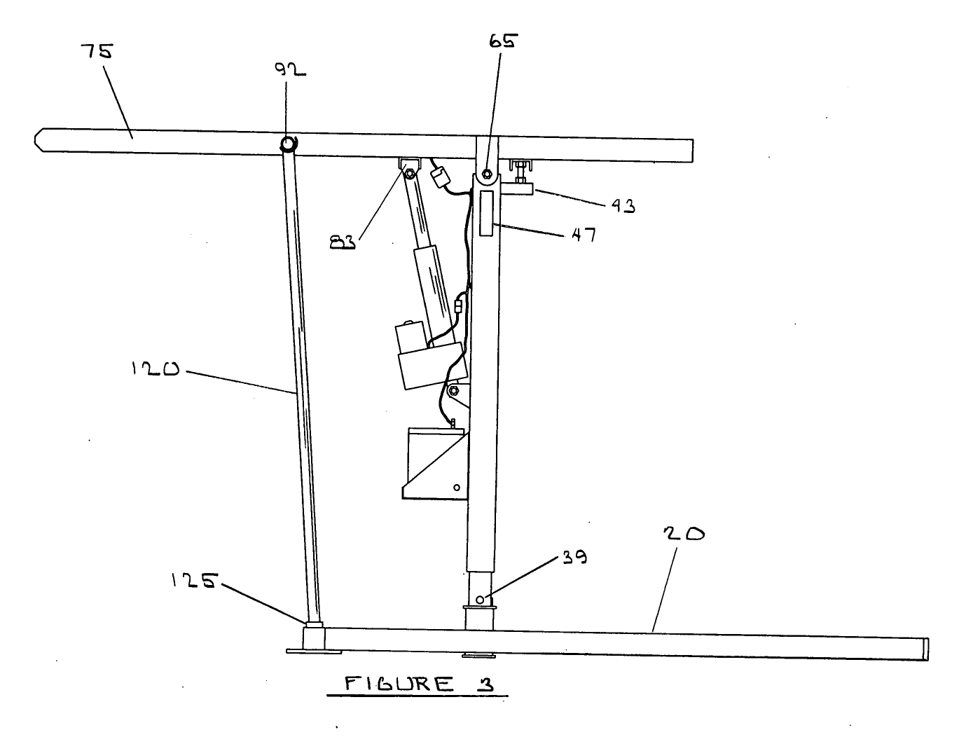

Central brace means 15 welded or otherwise mounted to base structure 10 configuration complementary for supporting a central mast 35 as will hereinafter be described. Furthermore central brace means 15 may be formed with any suitable tubular, plate, or channel material complementary with the construction of movable base structure 10 shown in FIG. 1 and 3.

Said movable base structure 10 constructed of a plurality of substantially identical support member legs 20 comprising elongated longitudinal members furthermore having attached therein a plurality of commercially available wheel 25 or other suitable rolling caster means mounted on the outer periphery of the movable base structure 10 in a configuration complementary to rolling a large structure.

Identical support member legs 20 preferably forming an A-framed structure as required fitting under vehicle or around tires as required. Additional support members generally horizontally arranged and interconnected by weld or other fastening means may additionally be utilized to strengthen and form base structure 10 as required.

Central brace member 15 shall have a centrally mounted sleeve 30 with a stop means in the bottom of said sleeve 30 for holding and engaging the central mast 35 wherein the perpendicularly attached and longitudinally extending centrally mounted sleeve 30 may have a set screw 32 or other suitable fastening means for the purpose of holding firm and in a fixed position the central mast 35.

Mast support 35 shall have a series of holes 39 diametrically opposed and spaced in equal segments along two sides of the mast 35 for the insertion of a height adjustment pin 41 designed for sliding within the diametrically opposed holes 39 Shown in FIGS. 1 and 3.

Central mast support beam 35 shall have a complementary sliding sleeve companion 37 sliding over and mounted upon central mast support 35 for the designed purpose of height adjustment wherein central mast 35 for the desired adjustment of the desired height.

Complementary sliding sleeve companion 37 shall sit upon a height adjustment pin 41 that is inserted into diametrically opposed holes 39 in central mast 35 for desired height adjustment positioning.

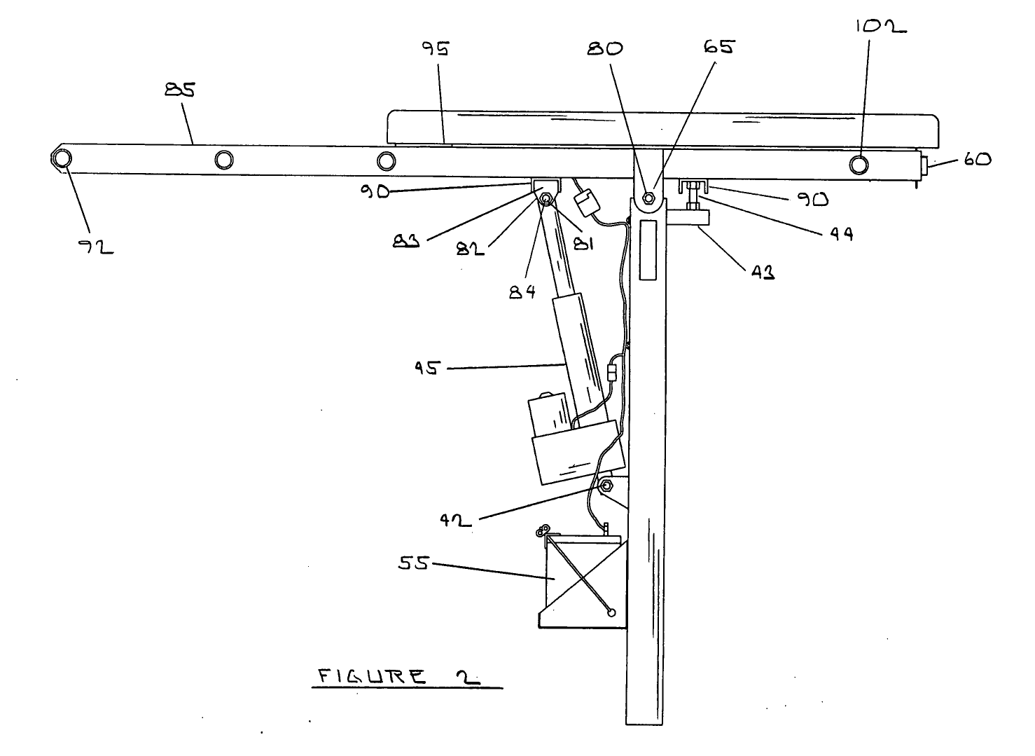

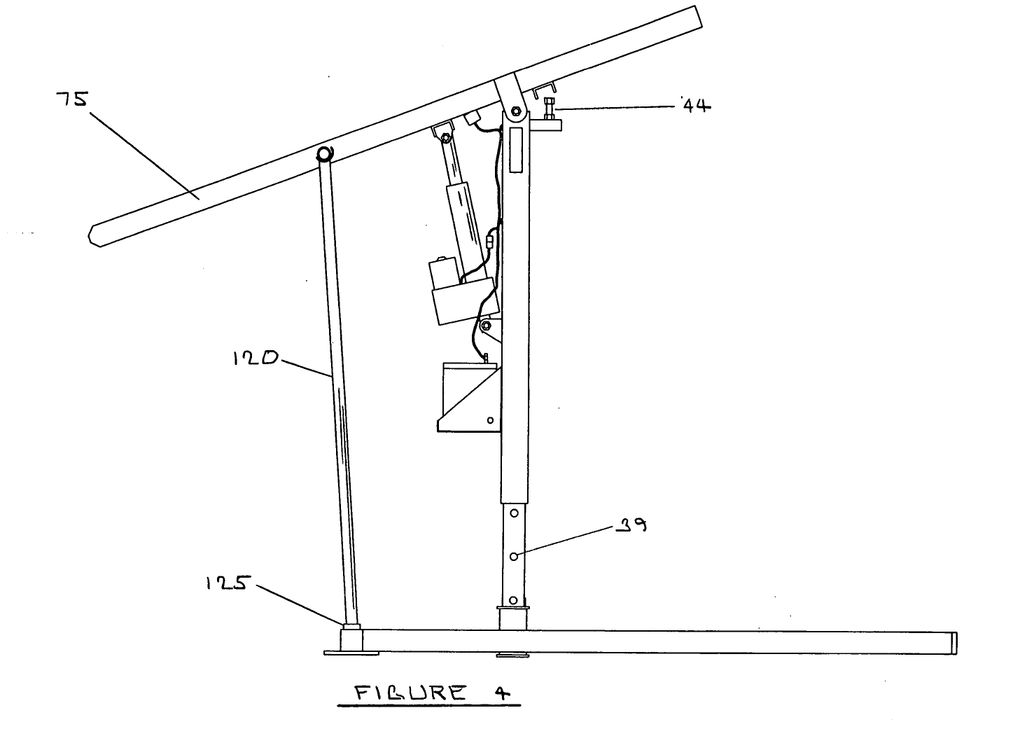

Sliding sleeve companion 37 shall furthermore have a plurality or pair of tangs 40 with diametrically opposed holes 42 complementary for receiving an electrically powered cylindrical screw jack 45 (FIG. 2) or like power means as may be commercially available. Sliding sleeve companion 37 shall also have a stop extension 43 welded or otherwise affixed to the upper portion of the structures for leveling adjustment of the movable platform base 75 via an adjustable bolt 44 shown in FIGS. 2 and 4.

Said central Sliding sleeve companion 37 furthermore having attached to its lower portion a support tray 50 for placement of a twelve or six volt battery 55 (FIG. 2) or like electrical power source for electrical power to electric powered cylindrical screw jack 45 via power switch 60 mounted as will hereinafter be defined.

Central sliding sleeve companion 37 shall have a coupling means 65 at the upper most portion wherein coupling means 65 wherein coupling means shall pivotally connect to movable platform 75 by means of a connection pin means 72 which may be inserted through a complementary bushing or sleeve means 70 for the purpose of facilitating a connection of the movable base structure 10 to movable platform 75.

Coupling means 65 may also include a configuration including but not limited to thread mounting such as bolts, screws, nut, or like construction means not shown herein shown in FIGS. 2 and 3.

Sliding sleeve companion 37 shall have an extension piece 46 attached for facilitating a connection to a vertical sleeve attachment means 47 for receiving a primary tool arm 48 for rotating engagement into vertical sleeve 47. Said primary tool arm 48 having at the opposite end or the extended arm member a pivoting connection means 49 for the connection of a secondary tool arm 51 best shown in FIG. 1.

Said secondary tool arm 51 having engagement means for rotating connection to primary tool arm 48 and having at the opposite end a connection means for attachment to a complementary connection means centrally disposed on a tool tray 52. Tool tray 52 preferably made of a rigid steel construction.

Tool tray 52 shall be horizontally aligned with the movable platform 75 when platform is in its horizontal and working mode thus serving the additional function of acting as a height guide wherein the tool tray may be extended to determine if the movable platform 75 can clear the engine compartment when making height adjustments.

Movable platform 75 shall comprise a frame constructed from two elongated tubular or channeled side members 85 generally horizontally arranged and interconnected by a series of transverse support members 90 fixedly attached and preferably welded to bottom of channeled side members 85 spaced in an arrangement shown for the purpose as will herein after be described. Movable platform 75 furthermore having a centrally mounted platform pivot connection 80 affixed to its centered lower portion for performing movement through out its arc or range of motion.

A second series of transverse support members 92 shall be equally spaced at the lowering end of the movable platform opposite sliding extension support 95 wherein transverse support members 92 may be constructed from square, round, channeled, or angled steel or like material and shall also serve as climbing rungs for gaining entry upon the movable platform 75.

Transverse support members 92 shall be vertically and evenly spaced apart and fixedly attached to the elongated side support members 85 in any suitable commercial construction means.

The transverse support member 90 on the lowering side of the movable platform 75 shall have a centrally placed connection means 82 comprising a pair of tangs 83 with diametrically opposed holes 84 for the purpose of pivotally connecting to the top connection means of the electric powered cylindrical screw jack 45 by means of a connection pin 81 or other suitable engagement means including but not limited to threaded connection means.

A secondary sliding frame 95 shall be mounted upon movable platform 75 in a complementary manner wherein the sliding frame 95 utilizes long extending members 100 extending through an open top end of or riding upon the top of side members 85 wherein a secondary sliding frame shall slide on wheels 97 or similar sliding device.

Secondary sliding frame 95 shall be comprised of cushioned platform 105 on a rigid board or squared structure and shall be securely mounted upon the extending members 100 wherein secondary extending members 100, wheels 97, and cushioned platform 105 comprise the extendable sliding frame 95.

A mechanic may adjust his extended length by pushing or pulling himself and making adjustments between the two platforms comprised of movable platform 75 and secondary sliding platform 95 by means of a pair of hand grips 102. Stop bolts 115 shall be mounted to side members 85 to control extension length of secondary sliding frame 95.

To work upon the platform the user climbs upon the transverse support members 92 acting as ladder rungs while the movable platform 75 is in a near vertical position causing the cushioned platform 105 affixed to the secondary platform 100 to retract over the movable platform 75 so that the user can comfortably lay up against the invention 5.

Upon climbing upon the inclined combined platforms 75 and 95 the user simply pushes the power switch 60 centrally located at the top portion of platform to adjust the inclined position of the platform. Upon reaching a horizontal or near horizontal position the user can easily adjust and extend the cushioned platform to reach the desired work area utilizing either hand grips 102 or by using his feet to press against support members 92 also utilized as rungs.

Height adjustment is facilitated by a height adjustment tool 120 wherein the movable platform 75 is powered to a level horizontal plain and the height adjustment tool 120 is placed in the socket 125 and connected to the uppermost support rung 92 by a saddle connection.

The power switch 60 may now be used to adjust the height of the invention 5 wherein the rung 92 facilitates a new pivot point wherein the electric power cylindrical screw jack 45 raises and lowers the sliding sleeve companion 37 my means of the power switch 60 and height adjustment pin 41 may be moved to desired hole 39 of setting proper height adjustment.

The height adjustment tool 120 is easily removed once the sliding sleeve companion 37 rests upon the height adjustment pin 41 inserted or otherwise engage in diametrically opposed holes 39.

In addition to providing the user an improved means for facilitating repairs upon high and large vehicles the invention 5 offers a safer means to reach hard to reach repair site and offers a stress free way to do repairs without straining the users back and other muscles.

Whereas the present invention has been described in particular relation to the drawings attached hereto, it should be understood that other and further modifications apart from those shown or suggested herein may be made within the scope of the invention. Reference herein to details of the illustrated embodiments is not intended to limit the scope of the invention, which are recited and those features regarded as essential to the invention are included within the claims.

### NUMBER SPECIFICATIONS

5—Invention
10—Base Structure
15—Central Cross Member
20—Outer Support Member
25—Wheels
30—Sleeve
32—Set Screw
35—Central Mast
37—Sliding Sleeve Companion
39—Aligning Holes
40—Tangs
41—Height Adjustment Pin
42—Holes in tangs
43—Stop extension
44—adjustable bolt
45—Electric powered cylindrical screw jack
46—extension connection
47—vertical sleeve
48—primary tool arm
49—pivot connection
50—Support Tray
51—Secondary tool arm
52—Tool tray
55—Battery
60—Power Switch
65—Coupling Means
70—Sleeve Bushing
72—Connection Pin
75—Movable platform
80—Platform Pivot Connection
81—Connection Pin
82—Connection Means
83—Tangs
84—Holes
85—Side Members
90—Transverse Support Members
92—Rung Support Member
95—Secondary Sliding Frame
97—Wheels
100—Extending Members
102—Hand Grips
105—Cushioned Platform
110—Roller assembly
115—Stop Bolt
120—Height Adjustable tool
125—Socket

What is claimed is:

1. Method and apparatus for repairing vehicles comprising an elevated and adjustable mechanic's platform comprising:
a) a movable base formed by a plurality of leg members connected to each other by a central support having a central sleeve;
b) an adjustable height central support mast wherein bottom of mask is in communication with sleeve in movable base;
c) an adjustable platform connected to said mast;
d) a electric powered cylindrical screw jack connected to central support mast and platform;
e) a power switch controlling the angle and height and adjustments of the platform

2. The invention of claim 1, wherein said plurality of leg members are further connected to a plurality of locking wheels.

3. The invention of claim 1, wherein an H shaped movable support base is utilized.

4. The invention of claim 1, wherein said mast has a non-electrical power means.

5. The invention of claim 1, further comprising a brake system not associated with the wheels that prevents movement of the base.

6. The invention of claim 1, further comprising an attachable pulling handle for ease of positioning.

7. The invention of claim 1, further comprising a plurality of tool trays.

8. The invention of claim 1, further comprising a height guide not comprising of a tool tray.

9. The invention of claim 1, further comprising hand rails.

10. The invention of claim 1, further comprising lighting means attached to platform.

11. The invention of claim 1, further comprising lighting means attached to tool tray.

12. The invention of claim 1, wherein electric power is replaced by pneumatic power.

13. The invention of claim 1, wherein pneumatic power is supplied by a shop compressor.

14. The invention of claim 1, wherein height adjustment is manual screw type adjustable apparatus.

15. The invention of claim 1, wherein height adjustment is a steel cable on a hand crank system.

16. The invention of claim 1, wherein no secondary support means is utilized.

17. The invention of claim 1, wherein structural foam or plastics replace steel components.

18. The invention of claim 1, wherein the platform extension is motorized.

19. The invention of claim 1, wherein the height adjustment tool is affixed to the moveable frame.

20. The invention of claim 1, wherein the height adjustment tool is affixed to the moveable frame and has a telescoping design.
